(19) United States
(12) Patent Application Publication
(10) Pub. No.: US 2011/0161427 A1
(43) Pub. Date: Jun. 30, 2011

(54) METHOD AND APPARATUS FOR LOCATION-AWARE MESSAGING

(75) Inventors: Sylvain Fortin, St-Laurent (CA); Nikolai Grigoriev, Brossard (CA); Haraldur Thorkelsson, Montreal (CA)

(73) Assignee: Nokia Corporation, Espoo (FI)

(21) Appl. No.: 12/647,782

(22) Filed: Dec. 28, 2009

(51) Int. Cl. G06F 15/16

(52) U.S. Cl. 709/206; 709/204

(57) ABSTRACT

An approach is provided for insertion of location-related information into a communication message. A communication message is received from an application resident on a mobile device, wherein the communication message specifies location-related information that includes addressing information or point-of-interest information, and the application includes either an electronic mail application, an instant messaging application, or a social networking application. The location-related information is extracted from the communication message. The location-related information is presented as an actionable item that triggers an action to be executed.

### BACKGROUND

Service providers (e.g., wireless, cellular, etc.) and device manufacturers are continually challenged to deliver value and convenience to consumers by, for example, providing compelling network services. However, these services, in general, require users to communicate information such as current location by manually entering an address or directions via a status update, email or instant message. This stems from the fact that location-based services and applications lack integration with communications applications. At best, mobile device manufacturers provide a user experience similar to that of desktop computers, but with even less integration of applications because of constraints relating to operating system functionality and processing power. Even if typical desktop computing functionality were possible, a user's ability to readily manipulate information is greatly encumbered. For example, when a user types in an address launching a mapping application to display a map of the location, the user would need to then copy and paste (assuming such capability exists) that map into a communication (e.g., email message). Thus, such schemes are especially cumbersome and time consuming when effected on mobile devices with limited display size and limited input mechanisms.

### SOME EXAMPLE EMBODIMENTS

Therefore, there is a need for an approach for improving the ease with which location-related information can be inserted into a communication message associated with a user device application.

According to one embodiment, a method comprises causing, at least in part, receipt of a communication message from an application resident on a mobile device. The communication message specifies location-related information that includes at least addressing information or point-of-interest information, and the application includes at least electronic mail functionality, instant messaging functionality, or a social networking functionality. The method also comprises extracting the location-related information from the communication message; and causing, at least in part, presentation of the location-related information as at least one actionable item capable of executing an action, causing at least in part an automatic action without presentation of the at least one actionable item, or both causing at least in part the presentation and the automatic action.

According to another embodiment, an apparatus comprises at least one processor and at least one memory including computer program code, where the at least one memory and the computer program code are configured to, with the at least one processor, cause the apparatus to perform at least the following. The apparatus receives a communication message from an application resident on a mobile device, wherein the communication message specifies location-related information that includes at least addressing information or point-of-interest information, and the application includes at least electronic mail functionality, instant messaging functionality, or a social networking functionality. The apparatus further extracts the location-related information from the communication message, and presents the location-related information as at least one actionable item capable of executing an action, causing at least in part an automatic action without presentation of the at least one actionable item, or both causing at least in part the presentation and the automatic action.

According to one embodiment, computer-readable storage medium carrying one or more sequences of one or more instructions which, when executed by one or more processors, cause an apparatus to at least perform the following: causing, at least in part, receipt of a communication message from an application resident on a mobile device, wherein the communication message specifies location-related information that includes at least addressing information or point-of-interest information, and the application includes at least electronic mail functionality, instant messaging functionality, or a social networking functionality. The apparatus also extracts the location-related information from the communication message, and presents the location-related information as at least one actionable item capable of executing an action, causing at least in part an automatic action without presentation of the at least one actionable item, or both causing at least in part the presentation and the automatic action.

According to yet another embodiment, an apparatus comprises means for causing, at least in part, receipt of a communication message from an application resident on a mobile device. The communication message specifies location-related information that includes at least addressing information or point-of-interest information, and the application includes at least electronic mail functionality, instant messaging functionality, or a social networking functionality. The apparatus also comprises means for extracting the location-related information from the communication message; and means for causing, at least in part, presentation of the location-related information as at least one actionable item capable of executing an action, causing at least in part an automatic action without presentation of the at least one actionable item, or both causing at least in part the presentation and the automatic action.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A-1D, are, respectively, a diagram of a system capable of inserting location-related information into a communication generated by an application on a mobile device, and flowcharts of processes for rendering messages using location-related information, according to various embodiment;

FIG. 2 is a diagram of the components of a user equipment, according to one embodiment;

FIG. 3 is a flowchart of a process for enabling insertion of location-related information into a communication message, according to one embodiment;

FIG. 4 is a flowchart of a process for presenting location-related information in a message as an actionable item, according to one embodiment;

FIGS. 5A-5C are diagrams of user interfaces utilized in the processes of FIG. 3, according to various embodiments;

FIGS. 6A-6C are diagrams of user interfaces utilized in the process of FIG. 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for improving the ease with which a location can be inserted into a communication message associated with a user device application are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

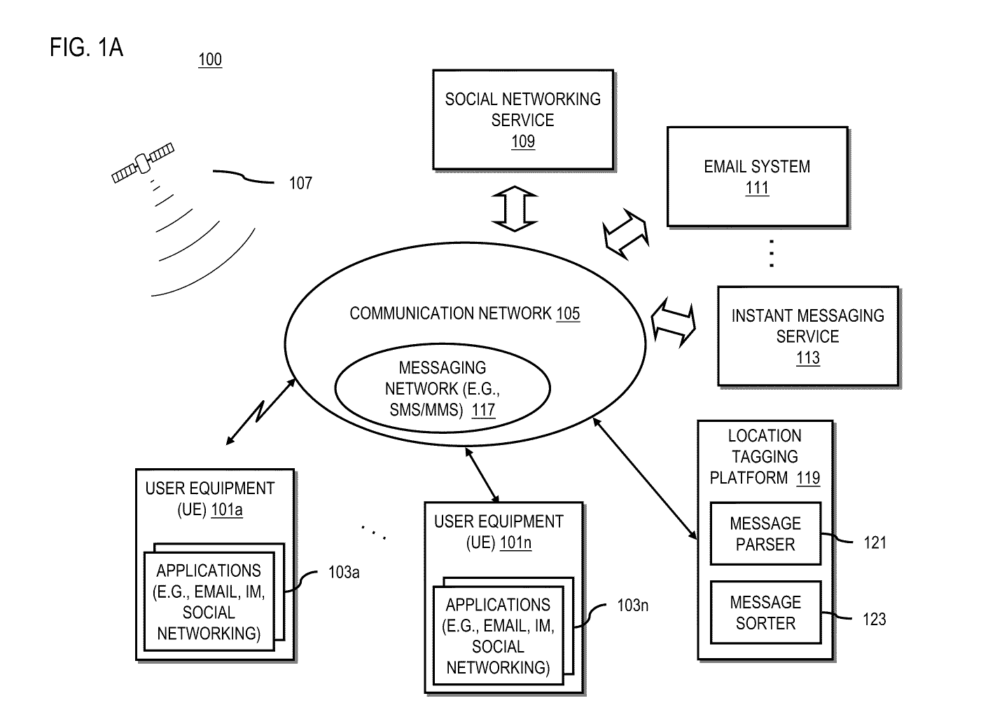

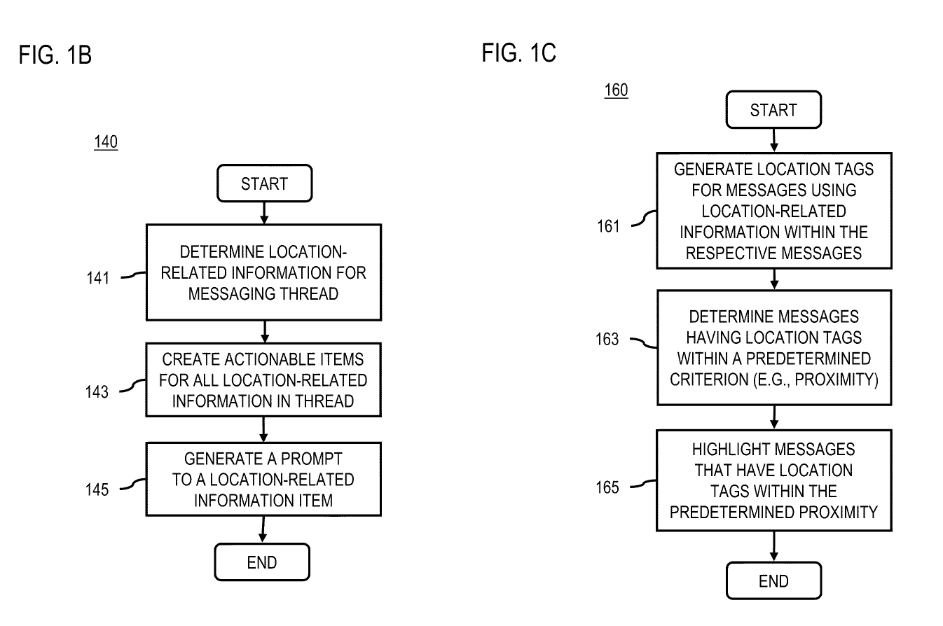

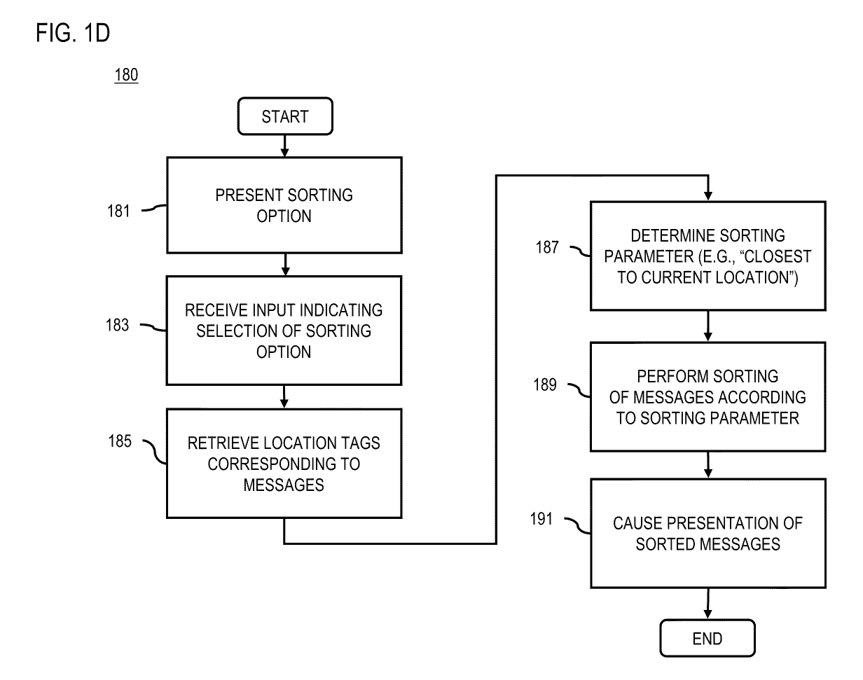

FIGS. 1A-1D, are, respectively, a diagram of a system capable of inserting location-related information into a communication generated by an application on a mobile device, and flowcharts of processes for rendering messages using location-related information, according to various embodiment. Mobile devices are becoming increasingly sophisticated, with many now equipped with navigational applications and devices (e.g., GPS devices). Developers too are increasingly creating applications for mobile devices that make use of location-related data. However, users of such devices are typically required to type in an address to provide their location to such applications, which is not only inconvenient for users but can also result in incorrect address entry and wrong or ineffective directions.

To address this problem, system 100 of FIG. 1A introduces, in certain embodiments, the capability to provide location-related information of a mobile device for insertion into a communication message associated with an application on the mobile device. According to one embodiment, the system 100 allows for determining an address based on geospatial data of a mobile device and inserting the address into, for example, a status update message associated with a social networking application (e.g., Facebook, Twitter, MySpace, LinkedIn, etc.). In another embodiment, the system 100 enables determination of a point of interest (POI) near the mobile device and insertion of the POI into the status update message. Other embodiments allow for the address or POI to be inserted into an instant message sent to an instant messaging service or into an email message sent to an email system. Additionally, the user can manually enter—e.g., by typing—an address using the mobile device for insertion into, for example, a status update message. An advantage of integration the insertion of location information within other communication messages is that users can more efficiently disseminate their whereabouts to other users, without having to expend battery power to manually manipulate information. Thus a means for conveniently inserting location information into communication messages is used in some embodiments.

Under the scenario of FIG. 1A, system 100 includes user equipments 101a-101n having connectivity to various services via a communication network 105. As used herein, one embodiment provides UEs 101a-101n, each having one or more applications 103a-103n resident thereon for generation of communication messages. Applications 103a-103n can include, for example, a social networking application for generating a status update message, an instant messaging application for generating an instant message, and an email application for generation of an email message, etc. The system 100 enables users, via a UE 101a, to insert location-related information for the UE 101a into a status update message to be posted to a social networking service 109. Other UEs 101b-101n can access the social networking service 109 to retrieve the contents of the message, which include the location of the posting UE 101a. The UEs 101a-101n can similarly utilize, in various embodiments, resident social networking, email and instant messaging applications 103a-103n to send and receive messages.

In one embodiment, a UE 101 determines location-related information by determining its geospatial data and associating the data with one or more addresses and/or POIs. In the example system 100 depicted in FIG. 1, the UE 101 uses a global positioning system (GPS) as tracking mechanism, where the GPS uses a GPS satellite 107 to track the UE's position. In other example systems 100, the UE 101 may use alternative tracking mechanisms such as an Assisted GPS (A-GPS), a cell of origin system or other location tracking systems in addition to or in lieu of the GPS satellite 107. Further, if the current position of the UE 101 can not be determined—e.g., there is no GPS coverage and the other tracking mechanisms fail or are not available—the UE 101 can use the last recorded location of the UE 101.

A related embodiment associates the geospatial data with location-related information that can include addressing or point-of-interest information. For example, the UE 101 can translate geographic coordinates—i.e., latitude and longitude—determined by the GPS into an address or addresses close to that location using an appropriate web service or application—e.g., GeoName's Reverse Geocoding Services, Nokia's Social Location, etc.

Another embodiment enables a UE 101 to present the user with multiple addresses and/or POIs associated with the UE's geospatial data for selection of a single address. The user can select one of the presented addresses and/or POIs for insertion into the communication message. Alternatively, the user can slightly tweak the address and can even select an address independent of the location of the UE 101 as indicated by its geospatial data. Accordingly, the user can deceive message recipients as to the true location of the UE 101, or the user can provide location-related information for a future location.

According to one embodiment, the system 100 allows a user of UE 101 to select the granularity of an address to be inserted into a communication message. The user can adjust the settings on UE 101 to specify that location-related information for insertion into a message be limited to street, city or country or user can select the address granularity on a message or recipient level basis. As an example of the latter, the user can elect to display a street-level address to friends and a city-level address to work colleagues. In one embodiment, this location-related information can be supplied by the user as a sender or as a recipient of the message.

UE 101 can use the geospatial data or location-related information associated with the geospatial data to determine a context location, which can also be inserted into a communication message, in another embodiment. That is, if the UE 101 determines an address that is associated with a sender's work, the context information “at work” is appended to the address in the communication message.

Also, UE 101n can, in another embodiment, receive a communication message containing location-related information from an application resident on another UE 101a. In one embodiment, the system 100 detects a location link in the message and executes a mapping application resident on the UE 101n. Other messages may contain location-related information—e.g., an address, a POI name, a phone number or a venue name—in the text of the message. The system 100 extracts the location-related information from the incoming message, and the UE 101n presents the information as an actionable item. In certain embodiments, the communication message may not be “opened” until the recipient UE 101n enters a predetermined location (e.g., same location as the sender). As mentioned, according to one embodiment, location-related information of the UE 101n can also be supplied by the UE 101n as the recipient in response to the received message.

As shown in FIG. 1, the system 100 comprises UEs 101 having connectivity to a social networking service, an email system or an instant messaging service via a communication network 105. By way of example, the communication network 105 of system 100 includes one or more networks such as a data network (not shown), a wireless network (not shown), a telephony network (not shown), a messaging network 117 or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like. Moreover, the messaging network 117 can provide, according to certain embodiments, services such as email, instant messaging (IM), social networking services, SMS messaging (e.g., text messaging), MMS messaging or other messaging communication.

The messaging network 117 can provide for SMS messaging and/or MMS messaging capabilities. The messaging network 117 may be a part of a telephony network (e.g., a cellular network). As part of a cellular network, UE 101 can communicate with a cellular tower to send and receive data including SMS messaging and MMS messaging. Cellular towers communicate with a UE 101 via control channels so that the UE 101 is able to ascertain which cellular tower to connect to. A control channel can also be utilized to deliver messages. A message can be sent to a UE 101 via a cellular tower and an MSC. The MSC can be used as a medium between the cellular network and internet protocol networks designed to carry messaging traffic. The message can have information about the message and the destination such as the length of the message, a time stamp, the destination phone number, etc., which can be used to route the message to the destination. In one example, social networking platform 109 can send a message to the UE 101 via the messaging network 117 by sending the message to the MSC via an internet protocol network. Then, the MSC can deliver the message to the UE 101 via the cellular tower control channel.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). Moreover, the UE 101 may execute one or more software applications or utilities, including but not limited to those for enabling or facilitating network access and communication, internet browsing, social networking, e-mail communication, file sharing and data transfer, word processing, data entry, spreadsheet processing, mathematical computation, etc. These applications and utilities may also be interoperable, so as to enable the execution of various features of the aforementioned application and utilities to be simultaneously executed to enable specific user tasks.

By way of example, the UE 101, social networking service 109, email system 111 and instant messaging service 113 communicate with each other and with other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

According to one embodiment, a location tagging platform 119 is provided for pre-processing messages to and from the UEs 103a-103n. For example, location tagging platform 119 can extract location-related information from these messages, and create location tags for the corresponding messages. The location tag, according to one embodiment, can be the actionable item. As shown, the platform 119 includes a message parser 121 configured to parse the messages for extraction of the location-related information. In one embodiment, location tagging platform 119 parses the incoming message for location-related information rather than the UEs 101a-101n. Such parsing can be performed for all messages—i.e., from senders and recipients. In general, as compared to the UE, the platform 119 can be configured with greater processing power, and thus, and more reference data against which to compare location-related information can be processed. Moreover, network-side parsing of messages permits more advanced detection of location-related information.

In one embodiment, the platform 119 does not require a location link, but rather generates a location link by associating a textual address, phone number, or venue name in the incoming message with relevant information on a data cloud or external data source (neither of which are shown).

In one example, the system 100 parses a message that includes a phone number and makes the phone number actionable or “clickable.” Selection of the actionable item by a user of the UE 101n triggers an action, such as execution of an application resident on the UE 101n in a related embodiment. For example, a user's clicking (or activation) of an actionable phone number in a message displayed on the UE 101n causes the UE 101n to dial the number and display an address or Point-of-Interest (POI) associated with the number in, for instance, a mapping application, whereby the user can access all of the features of that application.

In another example, the platform 119, via the parser 121, can parse a message that includes a POI to make the POI actionable. Selection of an actionable POI—e.g., by clicking on the POI name—can trigger a search of key terms related to the POI. Additionally, this selection can initiate display of the POI location on a map, as well as directions to the POI, etc. For example, selection of the POI “The White House” can trigger a search of items such as “The Oval Office, President Barack Obama, the Executive Branch, Washington D.C.,” etc.

In other embodiments, location tagging platform 119 can detect and create actionable events in incoming messages. For example, selection of an actionable concert event might trigger provision of a link to the artist or his music and a map of and directions to the venue. The platform 119 can also parse messages for location-related context. For example, a message may specify items on a shopping list. These shopping items can be made actionable by the platform 119 such that selection of a particular item would trigger the display of the name of a store offering the item for sale or at a discount, a map and directions to such a store, etc.

Platform 119 can also provide status updates to be displayed with a hyperlink and a thumbnail to an address associated with the location-related information in the status update. In this way, the location can be displayed directly on the website associated with the social networking service 109. With activation of the hyperlink using on a PC, for example, by the user, this triggers execution of a mapping application, which displays the associated street address. Alternatively, activating the hyperlink on a mobile device (e.g., UE 101a), on the other hand, may trigger display of the associated address as described above—i.e., in a mapping application, wherein the user can access all of the features of a rich map application.

It is noted that although automatic “requesting” of the recipient's location can be based on the recipient's presence attributes in, for example, IM by extracting the location information from the user's status text in a social network service.

In certain embodiments, system 100 enables various rendering techniques, as shown in FIGS. 1B-1D. For example, location-related information in a thread of messages can be made actionable from any of the messages in the thread. In one embodiment, a messaging thread comprises multiple messages involving among two or more participants. For instance, an original message is transmitted by a sender to two recipients, and each of the recipients responds to the original message; in this case, the messaging thread would include the original message as well as the messages generated in response to this original message. According to one embodiment, the location-related information is provided for both sender and recipient, such that the information made a part of the thread. Typically, the messaging thread pertains to a common topic. As shown in FIG. 1B, process 140 permits convenient access to location-related information within the entire thread, irrespective of where the information is located along the thread. In step 141, the process 140 determines all location-related information within the entirety of the messaging thread. Actionable items for all the determined location-related information are then created, as in step 143. In step 415, the process 140 can generate a prompt to permit the user to easily find one of the location-related information items (e.g., actionable items) within the messaging thread. In a situation where a message early in the thread contains event information and a message later in the thread contains location information, the user reading about the event in the first message can skip (or jump) to a pertinent part in the messaging thread providing the location information—i.e., directly access the location-related information even though the location information may appear later in the messaging thread, which may not even have been read by that user.

Furthermore, the platform 119 may employ another rendering technique that enables highlighting of messages in a recipient's inbox, as shown in FIG. 1C. In step 161, process 160 generates location tags for messages using location-related information within the messages. In one embodiment, the location tags can be the actual location-related information or information derived therefrom as to permit determination of distances (and hence proximity). Next, the process 160 determines, as in step 163, messages that possess location tags within a predetermined proximity—e.g., within 100 yards, 0.5 miles, etc. Thereafter, the messages satisfying this criterion are highlighted, per step 165. This approach can permit a user to manipulate the user's messages according to distances, in addition to the traditional parameters of time, sender, subject, file size, etc. For example, the highlighted messages may contain location-related information close to the recipient's current location.

Furthermore, location tagging platform 119 provides the flexibility to pre-sort messages according to various sorting parameters, as shown in FIG. 1D. In step 181, process 180 can present a sorting option to a user. In turn, the user can provide a selection input, indicating the sorting option, as in step 183; at this step, the user can specify the sorting parameter, or utilize a default option (e.g., “closest to current location”). In step 185, location tags corresponding to the messages are retrieved. The process 180 then determines the sorting parameter, per step 189, and cause the presentation of the sorted messages.

For instance, messages can be sorted by distance or location relevance. In one example, the user can have multiple views of a message inbox. In a standard view, the user's messages are displayed in order by send/receive time, while a filtered view displays only those messages relevant to the user's current location, ordered, for example, by distance using location links associated with the messages. Accordingly, the user can conveniently find a message sent in London or a message about a nearby restaurant received the previous year. Locating the latter message using the standard view, wherein messages are ordered by date of receipt, would require the user to scroll through all of the messages received in the last year. However, the filtered view would display the message about the nearby restaurant close to the top of the message list because of its proximity to the user. Of course, the standard and location-filtered views would be available for sent and received messages, as well as for message archive folders.

The processes of FIGS. 1B-1D can alternatively or in addition to being implemented on the network-side, can be deployed on the user-side.

Although the system 100 is described with respect to a social networking service, email system, and instant messaging service, it is contemplated that the location-aware messaging capability can be applied to other communication services.

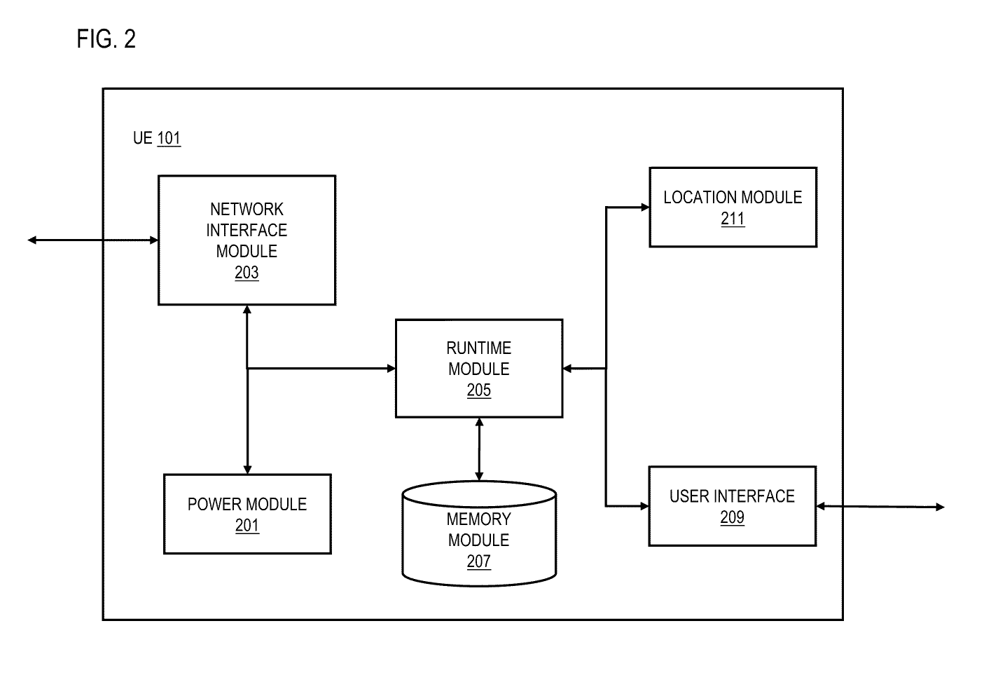

FIG. 2 is a diagram of the components of a UE 101, according to one embodiment, according to one embodiment. By way of example, the UE 101 includes one or more components for providing control of the UE 101. It is contemplated that the functions of these components may be combined in one or more components or performed by other components of equivalent functionality. In this embodiment, the UE 101 includes a power module 201, a network interface module 203, a runtime module 205, a memory module 207, a user interface 209 and a location module 211.

The power module 201 provides power to the UE 101. The power module 201 can include any type of power source (e.g., battery, plug-in, etc.). Additionally, the power module can provide power to the components of the UE 101 including processors, memory and transmitters.

In one embodiment, a UE 101 includes a network interface module 203. The network interface module 203 can be used by the runtime module 205 to communicate with one or more services, including a social networking service 109, an email system 111 and an instant messaging service 113. In some embodiments, the social networking service 109 is used to keep track of the status of a user of the UE 101. In another embodiment, the network interface module 203 is used to communicate with the social networking service 109 via a communication network 105.

In one embodiment, a UE 101 includes a user interface 209. The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, etc. A user can input a request to upload or receive object information via the user interface 209. In one embodiment, the user interface 209 displays a web browser. In this embodiment, the runtime module 205 receives a request from a user input and stores the request in the memory module 207. In another embodiment, the user interface 209 displays text messaging. In yet another embodiment, the runtime module 205 executes an application 103 associated with a social networking service, an email system or an instant messaging system that is displayed on the user interface 209.

In one embodiment, the UE 101 includes a runtime module 205 that can process a user's requests via a user interface 209 and execute at least one of a social networking application, an email application and an instant messaging application 103. In one example, a user can post a message—e.g., a status update—to a social networking service using a social networking application 103a via a network interface module 203. During generation of the message for posting, the application 103a can determine a location of the UE 101a using a location module 211 and then associate that location with an address or POI. In one embodiment, the runtime module 205 receives the location of the UE 101a—e.g., the geographic coordinates—from the location module 211 and sends the location to a reverse geocoding web service via network interface module 203 or to a reverse geocoding application. After determining the associated addresses and/or POIs, the runtime module 205 sends them to the social networking application 103a for presentation via the user interface 209 to the user. Once an address or POI has been selected and inserted into the status update message, the runtime module 205 sends the message to the social networking service via network interface module 203. Thus location inserting means for including location information in messages exchanged over a social networking service, email system, and instant messaging system, etc., is anticipated.

In one embodiment, the UE 101 includes a location module 211. This location module 211 can determine a user's geospatial location. The user's location can be determined by a triangulation system such as GPS, A-GPS, Cell of Origin, or other location extrapolation technologies, as well as proximity location indicators, such as a signal from a wireless local area network (WLAN), a Bluetooth® system, or the like. Standard GPS and A-GPS systems can use satellites 107 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 211 may also utilize multiple technologies to detect the location of the UE 101. For instance, a GPS system may narrow the location of the UE 101 to a building and a WLAN signal can determine UE 101 locations within the building. In one embodiment, the position of the UE 101 can be determined by detecting WLAN access point availability.

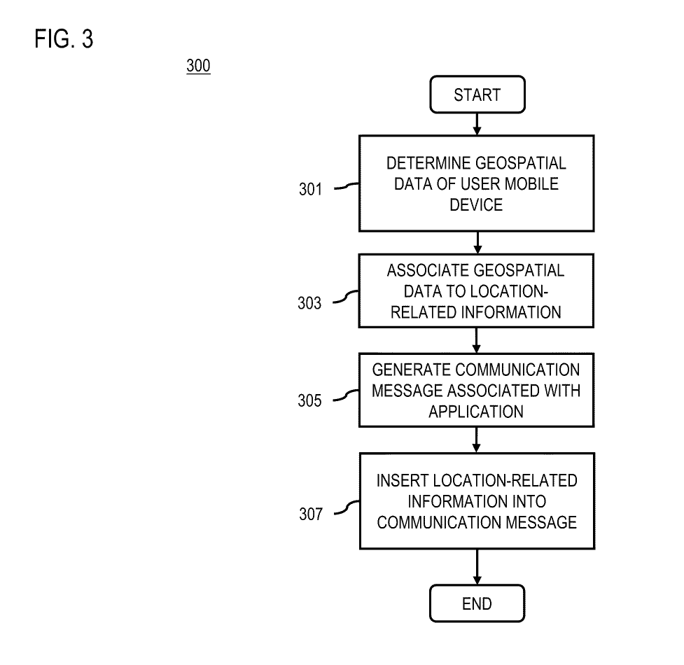

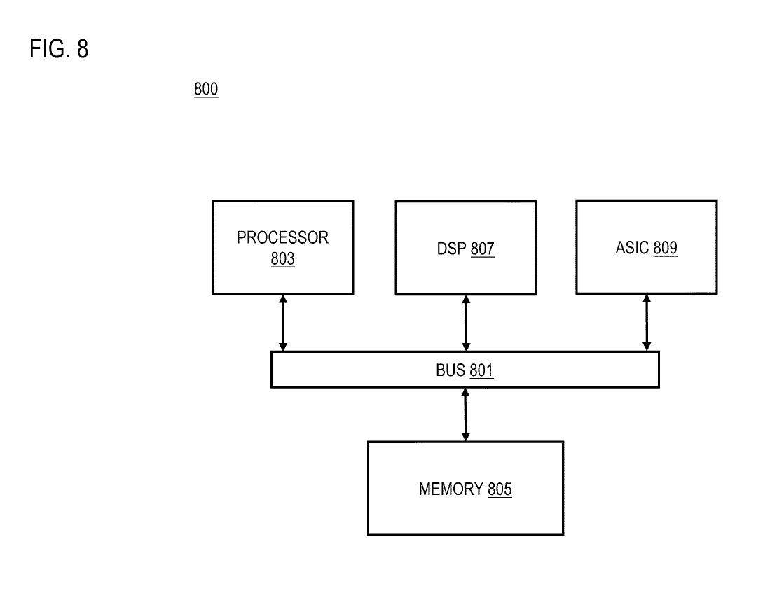

FIG. 3 is a flowchart of a process for enabling insertion of location-related information into a communication message, according to one embodiment. In one embodiment, the runtime module 205 performs the process 300 and is implemented in, for instance, a chip set including a processor and a memory as shown FIG. 8. In step 301, the mobile device receives geospatial data relating to its location.

At step 303, the mobile device (e.g., UE 101) associates the geospatial data to location-related information. Such location-related information can include one or more addresses and/or POIs near the determined geospatial location of the mobile device 101. The location-related information can also be independent of the geospatial data of step 301.

At step 305, the mobile device 101 generates a communication message associated with an application resident on the mobile device 101. Examples of applications can include social networking applications, instant messaging applications, email applications, etc. At step 307, the location-related information determined in step 303 is inserted into the communication message of step 305. As mentioned with respect to FIG. 1A above, the user can specify the granularity of the location-relation information inserted into the communication message.

The mobile device 101 can perform the above process when composing and sending the communication message, or when responding to a message. In this manner, even though the originator of the message does not supply its location, the mobile device 101, as a recipient, can generate a reply with location-related information of the device 101. For example, if the recipient device 101 produces an “out-of-office” reply, such response will include the location. As such, the sender device can determine whether there is a high likelihood of receiving a true response within a short period of time; that is, if the recipient is at a location that suggests vacation travel as opposed to business travel, then it is not likely that a response can be reasonably expected within normal business practices.

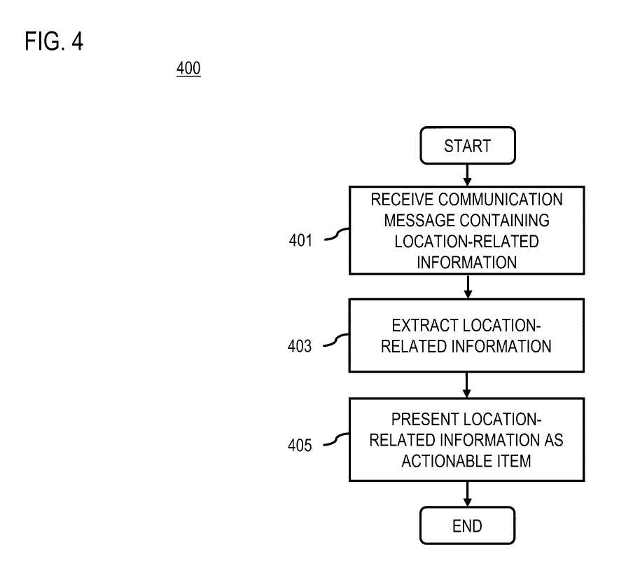

FIG. 4 is a flowchart of a process for presenting location-related information in a message as an actionable item, according to one embodiment. In one embodiment, the runtime module 205 performs the process 400 and is implemented in, for instance, a chip set including a processor and a memory as shown FIG. 8. In step 401, the mobile device 101 receives a communication message that includes at least one piece of location-related information. Such location-related information can include an address, a phone number, a venue, etc.

At step 403, the mobile device 101 extracts the location-related information from the incoming message and, at step 405, the mobile device 101 presents the location-related information as actionable item(s). That is, the mobile device 101 displays the location-related information in such a way that makes it clear to the user that such items are actionable—e.g., by highlighting, underlining or coloring the text of the item. According to one embodiment, the actionable item is capable of executing an action, causing an automatic action without presentation of the actionable item, or the combination of both of these scenarios. In such a case, a user's clicking on or otherwise selecting an actionable item results in the mobile device 101's performance of an action such as dialing a phone number or displaying a map showing an address.

It is contemplated that some or all of the processes of FIGS. 3 and 4 can alternatively or in addition to being implemented on the network-side, by location tagging platform 119.

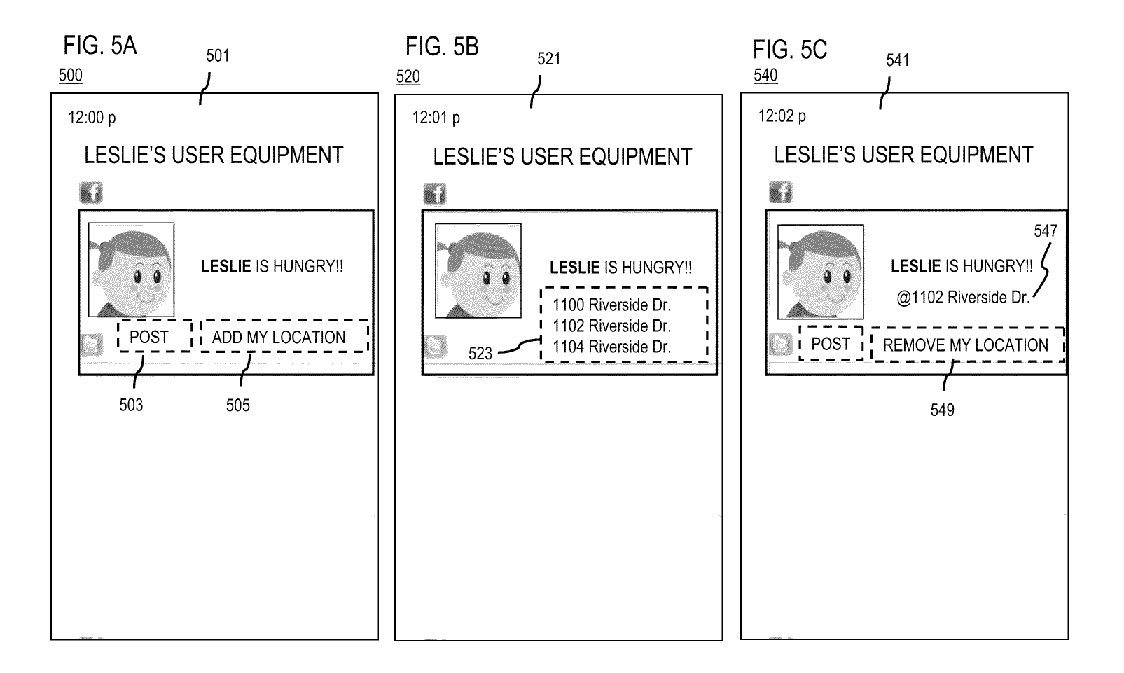

FIGS. 5A-5C are diagrams of user interfaces utilized in the process of FIG. 3, according to one embodiment. User interface 500 displays a social networking service representation 501 of, for example, a user named Leslie. Leslie is able to post a status update message with her location. In one embodiment, the social networking representation 501 can include a Post button 503 for posting the existing status update message and a Add My Location button 505 for adding Leslie's location to the message. In another embodiment, user interface 520 displays a list of addresses 523 near the mobile device in response to Leslie's having selected the Add My Location button 505. In a situation where only one address or POI is returned, the list 523 would not have been displayed. In this case, Leslie decides to select the second address, “1102 Riverside Dr.”. User interface 540 displays the status update message, which includes Leslie's location 547. One embodiment includes a Remove My Location button 549. Other embodiments of the user interfaces of FIGS. 5A-5C may include a Modify Address button whereby a user can enter a location not associated with his geospatial location or change the granularity of the displayed address—e.g., city level rather than street level.

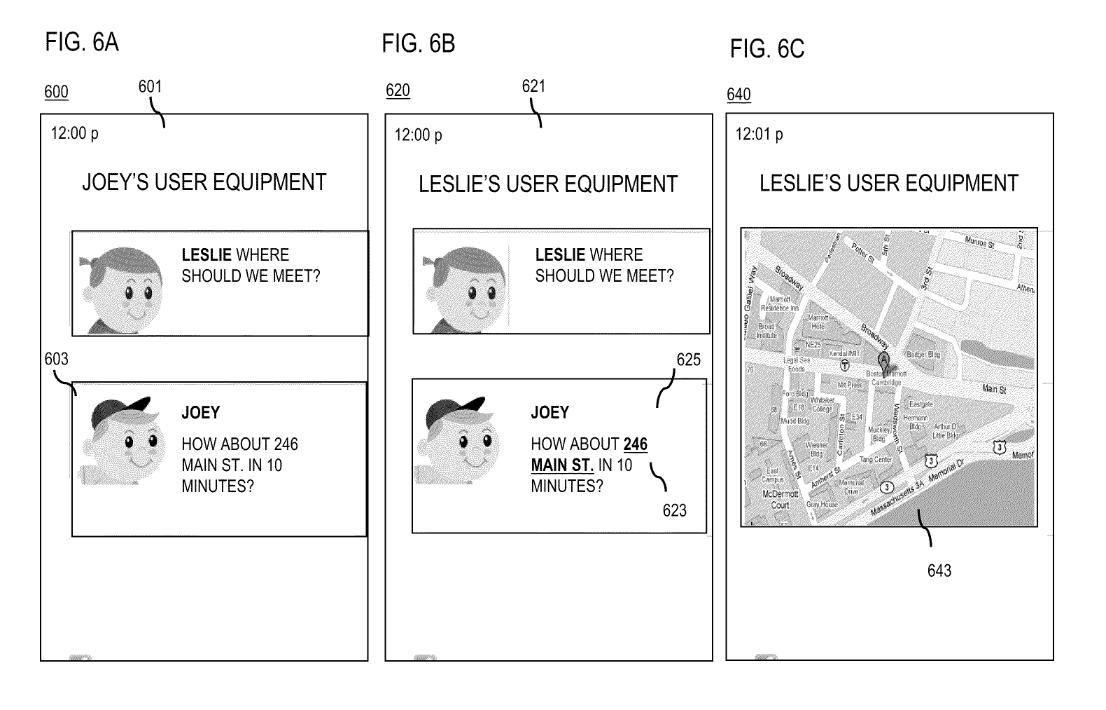

FIGS. 6A-6C are diagrams of user interfaces utilized in the process of FIG. 4, according to one embodiment. User equipment interface 600 displays an instant messaging service representation 601 of, for example, a user named Joey. In one embodiment, Joey sends Leslie an instant message 603 that includes an address in the text of the message. User equipment interface 620 shows an instant messaging service representation 621 for Leslie, wherein Joey's text message 625 suggests a meeting location. Within Joey's text message 625, the location-related information, “246 Main St.” 623 is highlighted—i.e., boldfaced and underlined—indicating to Leslie that the address is actionable. If Leslie selects the actionable address—i.e., by touching the screen on a mobile device or the touchpad on a laptop computer—Leslie's user equipment interface 640 displays a map of the address 643.

The above arrangement (and means) and processes, according to certain embodiment, advantageously provide an efficient approach to generating communications with location-related information. Effectively, such an arrangement provides integration of location-aware applications with existing communication applications. The approach also simplifies the actual entry of the information. Notably, when deployed in a mobile device with a small form factor, the number of key strokes within the mobile device is minimized, thereby enhancing the device's battery life.

The processes described herein for providing location-related information in a communication message may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

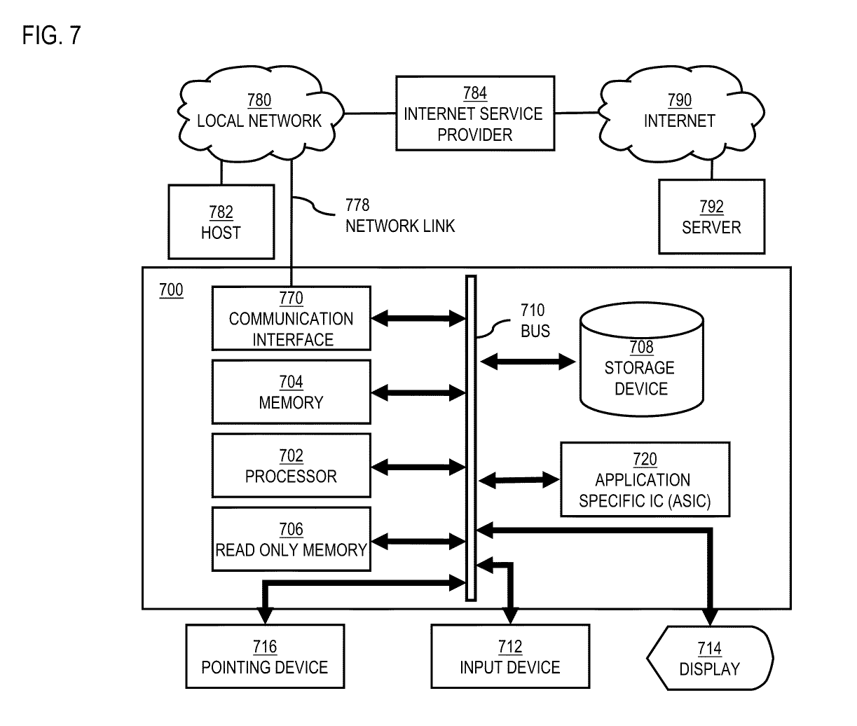

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide for insertion of location-related information into a communication message as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of inserting location-related information into a communication message.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to insertion of location-related information into a communication message. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for insertion of location-related information into a communication message. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for inserting location-related information into a communication message, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for insertion of location-related information into a communication message sent from the UE 101.

The term “computer-readable medium” as used herein to refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to enable insertion of location-related information into a communication message as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of inserting location-related information into a communication message.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to insert location-related information into a communication message. The memory 805 also stores the data associated with or generated by the execution of the inventive steps.

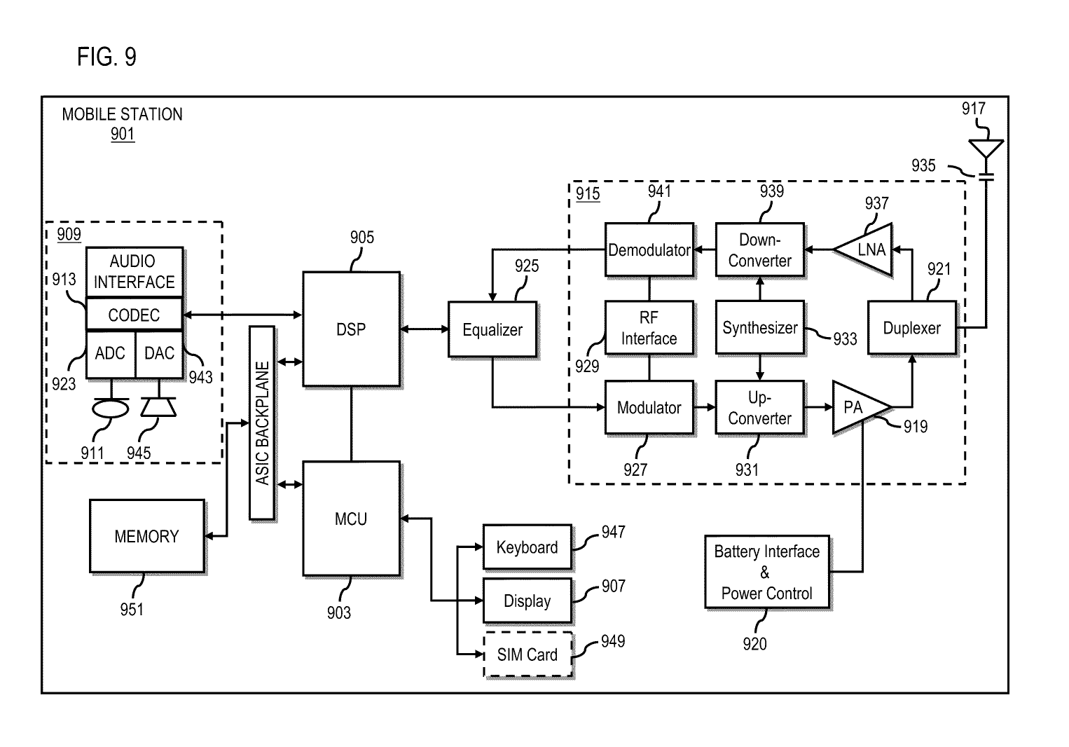

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of insertion of location-related information into a communication message. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of insertion of location-related information into a communication message. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide for insertion of location-related information into a communication message. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, receipt of a communication message from an application resident on a mobile device, wherein the communication message specifies location-related information that includes at least addressing information or point-of-interest information, and the application includes at least electronic mail functionality, instant messaging functionality, or a social networking functionality;
extracting the location-related information from the communication message; and
causing, at least in part, presentation of the location-related information as at least one actionable item capable of executing an action, causing at least in part an automatic action without presentation of the at least one actionable item, or both causing at least in part the presentation and the automatic action.

2. A method of claim 1, wherein the location-related information corresponds to geospatial data of the mobile device, and the action includes invoking another application, or initiating a communication session.

3. A method of claim 2, wherein the location-related information is selected by the mobile device from a plurality of location-related information that are within a predetermined proximity to the geospatial data.

4. A method of claim 1, wherein the communication message is part of a messaging thread that includes a plurality of communication messages, the method further comprising:
causing, at least in part, presentation of a prompt as the at least one actionable item to enable directly viewing the location-relating information within the messaging thread.

5. A method of claim 1, further comprising:
generating a location tag as the at least one actionable item for the communication message based on the location-related information;
determining whether the location tag satisfies a predetermined criterion; and
causing, at least in part, highlighting of the communication message if the predetermined criterion is satisfied.

6. A method of claim 1, further comprising:
generating a location tag as the at least one actionable item for the communication message based on the location-related information;
storing the location tag among a plurality of location tags corresponding to a plurality of communication messages; and
sorting the location tags according to a sorting parameter.

7. A method of claim 6, wherein the sorting parameter specifies proximity to the mobile device, the method further comprising:
causing, at least in part, presentation of the communication messages corresponding to the location tags that satisfy the sorting parameter.

8. An apparatus comprising:
at least one processor; and
at least one memory including computer program code,
the at least one memory and the computer program code configured to, with the at least one processor, cause the apparatus to perform at least the following,
receive a communication message from an application resident on a mobile device, wherein the communication message specifies location-related information that includes at least addressing information or point-of-interest information, and the application includes at least electronic mail functionality, instant messaging functionality, or a social networking functionality,
extract the location-related information from the communication message, and
present the location-related information as at least one actionable item capable of executing an action, causing at least in part an automatic action without presentation of the at least one actionable item, or both causing at least in part the presentation and the automatic action.

9. An apparatus of claim 8, wherein the location-related information corresponds to geospatial data of the mobile device, and the action includes invoking another application, or initiating a communication session.

10. An apparatus of claim 9, wherein the location-related information is selected by the mobile device from a plurality of location-related information that are within a predetermined proximity to the geospatial data.

11. An apparatus of claim 8, wherein the communication message is part of a messaging thread that includes a plurality of communication messages, the method further comprising:
present a prompt as the at least one actionable to enable directly viewing the location-relating information within the messaging thread.

12. An apparatus of claim 8, wherein the apparatus is further caused, at least in part, to:
generate a location tag as the at least one actionable for the communication message based on the location-related information;
determine whether the location tag satisfies a predetermined criterion; and
highlight the communication message if the predetermined criterion is satisfied.

13. An apparatus of claim 8, wherein the apparatus is further caused, at least in part, to:
generate a location tag as the at least one actionable for the communication message based on the location-related information;
store the location tag among a plurality of location tags corresponding to a plurality of communication messages; and
sort the location tags according to a sorting parameter.

14. An apparatus of claim 13, wherein the sorting parameter specifies proximity to the mobile device, and the apparatus is further caused, at least in part, to:
present the communication messages corresponding to the location tags that satisfy the sorting parameter.

15. A computer-readable storage medium carrying one or more sequences of one or more instructions which, when executed by one or more processors, cause an apparatus to at least perform the following steps:
causing, at least in part, receipt of a communication message from an application resident on a mobile device, wherein the communication message specifies location-related information that includes at least addressing information or point-of-interest information, and the application includes at least electronic mail functionality, instant messaging functionality, or a social networking functionality;
extracting the location-related information from the communication message; and
causing, at least in part, presentation of the location-related information as at least one actionable item capable of executing an action, causing at least in part an automatic action without presentation of the at least one actionable item, or both causing at least in part the presentation and the automatic action.

16. A computer-readable storage medium of claim 15, wherein the location-related information corresponds to geospatial data of the mobile device, and the action includes invoking another application, or initiating a communication session, the location-related information being selected by the mobile device from a plurality of location-related information that are within a predetermined proximity to the geospatial data.

17. A computer-readable storage medium of claim 15, wherein the communication message is part of a messaging thread that includes a plurality of communication messages, and the apparatus is caused, at least in part, to further perform:
presenting a prompt as the at least one actionable item to enable directly viewing the location-relating information within the messaging thread.

18. A computer-readable storage medium of claim 15, wherein the apparatus is caused, at least in part, to further perform:
generating a location tag as the at least one actionable item for the communication message based on the location-related information;
determining whether the location tag satisfies a predetermined criterion; and
highlighting of the communication message if the predetermined criterion is satisfied.

19. A computer-readable storage medium of claim 15, wherein the apparatus is caused, at least in part, to further perform:
generating a location tag as the at least one actionable item for the communication message based on the location-related information;
storing the location tag among a plurality of location tags corresponding to a plurality of communication messages; and
sorting the location tags according to a sorting parameter.

20. A computer-readable storage medium of claim 19, wherein the sorting parameter specifies proximity to the mobile device, and the apparatus is caused, at least in part, to further perform:
presenting the communication messages corresponding to the location tags that satisfy the sorting parameter.
